(19) United States
(12) Patent Application Publication
(10) Pub. No.: US 2023/0246514 A1
(43) Pub. Date: Aug. 3, 2023

(54) ELECTROMECHANICAL INTEGRATION UNIT

(71) Applicant: TOYOTA JIDOSHA KABUSHIKI KAISHA, Toyota-shi Aichi-ken (JP)

(72) Inventors: Keisuke YUKI, Toyota-shi Aichi-ken (JP); Yuya OKUDA, Toyota-shi Aichi-ken (JP)

(73) Assignee: TOYOTA JIDOSHA KABUSHIKI KAISHA, Toyota-shi Aichi-ken (JP)

(21) Appl. No.: 17/992,480

(22) Filed: Nov. 22, 2022

(30) Foreign Application Priority Data
Jan. 31, 2022 (JP) 2022-013463

(51) Int. Cl. H02K 5/22; H02J 7/34; H01R 13/447; H01R 13/62; H01R 13/10; H02K 7/00; H02K 7/116; H02K 11/00; H02K 11/33; B60L 50/60

(52) U.S. Cl. CPC H02K 5/225; H02J 7/342; H01R 13/447; H01R 13/62; H01R 13/10; H02K 7/006; H02K 7/116; H02K 11/0094; H02K 11/33; B60L 50/60; H02J 2207/20; H01R 2201/26

(57) ABSTRACT

An electromechanical integration unit mounted on a vehicle includes: a housing having a first chamber and a second chamber; a motor and a gear mechanism housed in the first chamber and connected to wheels of the vehicle; an electrical circuit unit housed in the second chamber and electrically connected to the motor; and a terminal unit housed in the second chamber and electrically connected to the electrical circuit unit and having a socket to which a connector of a power cable connected to a battery of the vehicle is detachably connected. In the second chamber, a connector insertion port that externally exposes the socket and in which the connector is provided so as to be insertable is provided, and in a range exposed to the outside through the connector insertion port, a pair of fastening portions for mutually connecting the terminal unit and the electrical circuit unit are provided.

### CROSS-REFERENCE TO RELATED APPLICATION

This application claims priority to Japanese Patent Application No. 2022-013463 filed on Jan. 31, 2022, incorporated herein by reference in its entirety.

### BACKGROUND

### 1. Technical Field

The technique disclosed in the present specification relates to an electromechanical integration unit.

### 2. Description of Related Art

Japanese Unexamined Patent Application Publication No. 2011-182480 (JP 2011-182480 A) discloses an electromechanical integration unit mounted on a vehicle. The electromechanical integration unit includes a housing provided with a first chamber and a second chamber, a motor or the like housed in the first chamber of the housing, and an electrical circuit unit provided in the second chamber of the housing.

### SUMMARY

In the above-described electromechanical integration unit, normally, one or more service holes are provided in the housing to fasten components disposed in the housing. However, providing the service hole in the housing may lead to an increase in the size of the housing and a decrease in rigidity. Accordingly, the present specification provides a technique that can reduce the number of service holes required.

An electromechanical integration unit according to a first aspect of the present disclosure is mounted on a vehicle. The electromechanical integration unit includes: a housing configured to include a first chamber and a second chamber; a motor and a gear mechanism housed in the first chamber of the housing and configured to be connected to a wheel of the vehicle; an electrical circuit unit housed in the second chamber of the housing and configured to be electrically connected to the motor; and a terminal unit housed in the second chamber of the housing and electrically connected to the electrical circuit unit, and configured to include a socket to which a connector of a power cable connected to a battery of the vehicle is detachably connected. Here, in the second chamber of the housing, a connector insertion port is provided so as to externally expose the socket and allow the connector to be inserted. Further, a pair of fastening portions for connecting the terminal unit and the electrical circuit unit to each other is provided in a range externally exposed through the connector insertion port.

According to such a configuration, the connector of the power cable extending from the battery is attached to and detached from the connector insertion port provided in the housing. The pair of fastening portions for connecting the terminal unit and the electrical circuit unit to each other is provided in the range externally exposed through the connector insertion port when the connector is detached from the connector insertion port. With the above, the connector insertion port can also function as a service hole for the fastening portions, and the number of service holes can be reduced accordingly. Further, when the connector insertion port closed by the connector is caused to function also as a service hole, a service hole cover indispensable to the service hole is also unnecessary. Therefore, it is also possible to reduce the number of parts required.

In the electromechanical integration unit according to the first aspect, the housing may be configured to include a housing body provided with an opening in the second chamber and a cover plate detachably attached to the opening of the housing body. Here, the terminal unit may be configured to be fixed to the housing body. Further, the electrical circuit unit may be configured to be fixed to the cover plate. According to such a configuration, after the cover plate is attached to the housing body, the terminal unit and the electrical circuit unit can be fastened to each other through the connector insertion port.

In the electromechanical integration unit according to the first aspect, the connector insertion port may be configured to be provided in the cover plate.

In the electromechanical integration unit according to the first aspect, one of the fastening portions may be configured to be located on one side of the socket, and the other of the fastening portions may be configured to be located on the other side of the socket. According to such a configuration, it is possible to reduce the opening area of the connector insertion port as compared with a case where both of the fastening portions are located on the same side of the socket. This makes it possible to reduce the size and improve the rigidity of the housing.

In the electromechanical integration unit according to the first aspect, the electrical circuit unit may be configured to convert a direct-current power supplied from the battery into an alternating-current power supplied to the motor.

The electromechanical integration unit according to the first aspect may further include a second electrical circuit unit housed in the second chamber of the housing and configured to be electrically connected to the terminal unit.

Here, the second electrical circuit unit may be configured to convert a direct-current power supplied from the battery to a charge power supplied to an auxiliary battery of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of an electromechanical integration unit 10;

FIG. 2 is a plan view of the electromechanical integration unit 10 as viewed from above, and shows the vicinity of the first connector insertion port 42c in detail;

FIG. 3 is a block circuit diagram showing an electrical configuration of the electromechanical integration unit 10.

### DETAILED DESCRIPTION OF EMBODIMENTS

### Embodiment

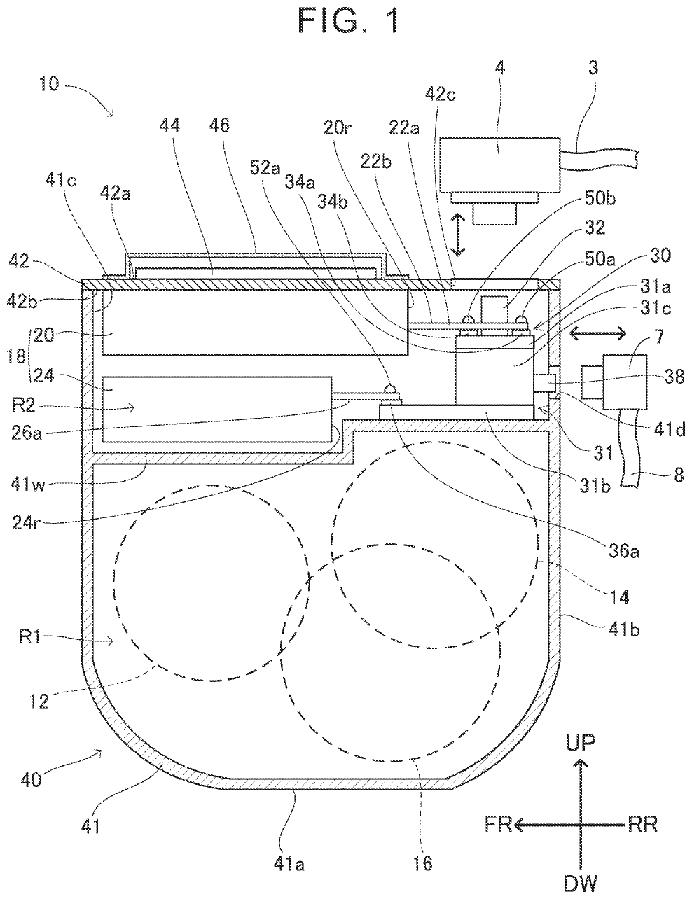

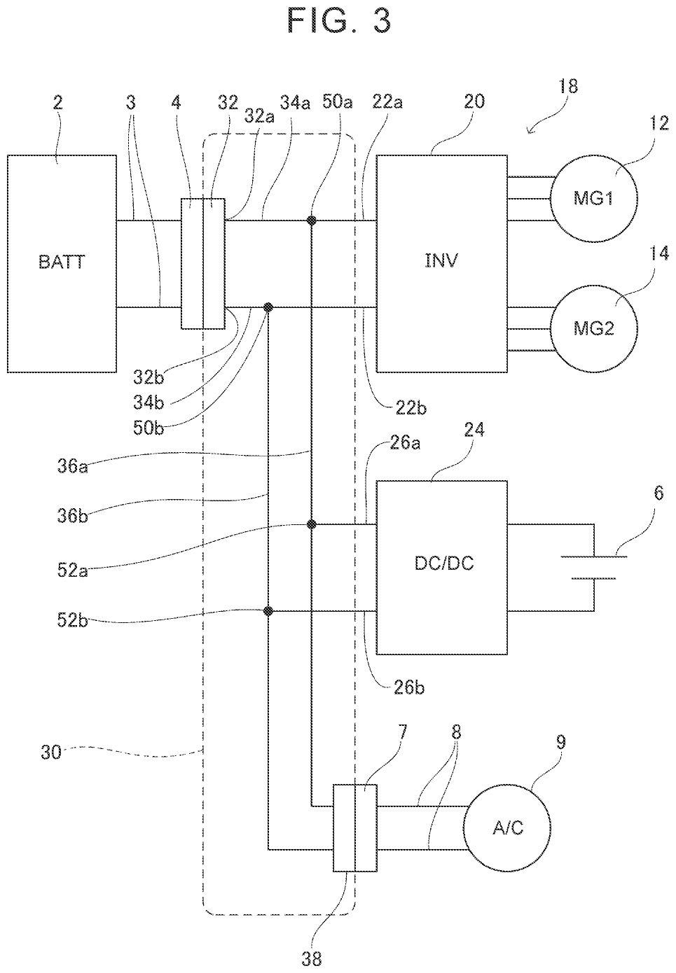

The electromechanical integration unit 10 of the embodiment will be described with reference to the drawings. The electromechanical integration unit 10 is mounted on a vehicle such as a hybrid vehicle. However, the vehicle is not limited to a hybrid electric vehicle, and may be an electrified vehicle such as a battery electric vehicle or a fuel vehicle. As shown in FIGS. 1 and 3, the electromechanical integration unit 10 includes a plurality of motors 12 and 14, a plurality of gear mechanisms 16, a plurality of electrical circuit units 18, a terminal unit 30, and a housing 40. The housing 40 integrally houses the plurality of motors 12 and 14, the plurality of gear mechanisms 16, the plurality of electrical circuit units 18, and the terminal unit 30.

Here, each direction of the electromechanical integration unit 10 in the drawings corresponds to a direction when the electromechanical integration unit is mounted on a vehicle, that is, a direction of the vehicle. Therefore, the direction FR indicates the front in the front-rear direction of the vehicle, and the direction RR indicates the rear in the front-rear direction of the vehicle. Further, the direction LH indicates a left direction in the left-right direction of the vehicle, and the direction RH indicates a right direction in the left-right direction of the vehicle. The direction UP indicates an upward direction in the up-down direction of the vehicle, and the direction DW indicates a downward direction in the up-down direction of the vehicle.

The housing 40 is a housing member. The housing body 41 is made of a conductive material such as aluminum. The housing 40 has a first chamber R1 and a second chamber R2. The second chamber R2 is located above the first chamber R1. The housing 40 includes a housing body 41 and a cover plate 42. The housing body 41 has a bottom wall 41a and four side walls 41b extending upward from the outer peripheral edge of the bottom wall 41a. The housing body 41 has an opening 41c in the second chamber R2 (that is, the upper portion). The opening 41c of the housing body 41 is defined by four side walls 41b. The housing body 41 is provided with a partition wall 41w. In the housing 40, the first chamber R1 and the second chamber R2 are defined by the partition wall 41w. The cover plate 42 is detachably attached to the opening 41c of the housing body 41. The cover plate 42 closes the opening 41c of the housing body 41. The cover plate 42 is a plate-shaped member, and is made of a conductive material such as aluminum.

A plurality of motors 12 and 14 and a plurality of gear mechanisms 16 are disposed in the first chamber R1 of the housing 40. The plurality of motors 12 and 14 are driving motors that drive wheels of the vehicle. The plurality of motors 12 and 14 includes a first motor 12 and a second motor 14. The plurality of gear mechanisms 16 includes a planetary gear mechanism, a reduction gear mechanism, and a differential gear mechanism. The plurality of motors 12, 14 and the plurality of gear mechanisms 16 are connected to the wheels of the vehicle. Specifically, the plurality of motors 12 and 14 are connected to the wheels via a plurality of gear mechanisms 16. The electromechanical integration unit 10 outputs the power of the plurality of motors 12 and 14 driven by the electric power from the battery 2 of the vehicle to the wheels via the plurality of gear mechanisms 16. However, the motors 12 and 14 are not limited to a plurality of motors (two motors in the present embodiment), and may include at least one motor. In addition, the gear mechanism 16 may not include a plurality of gear mechanisms as described above, and may include at least one gear mechanism.

A plurality of electrical circuit units 18 and terminal units 30 are arranged in the second chamber R2 of the housing 40. The plurality of electrical circuit units 18 includes inverters 20 and DC-DC converters 24. The terminal unit 30 includes a terminal block 31, an input socket 32, and an output socket 38. The terminal unit 30 is electrically connected to the inverters 20 and DC-DC converters 24 via the terminal blocks 31. The connector 4 of the power cable 3 connected to the battery 2 of the vehicle is detachably connected to the input socket 32 of the terminal unit 30. The terminal unit 30 receives the supply power of the battery 2 of the vehicle from the input socket 32. The terminal unit 30 can output power input from the input socket 32 to the inverters 20, DC-DC converters 24, and the output sockets 38, respectively.

In the second chamber R2, the inverter 20 is fixed to the cover plate 42 of the housing 40. Although not particularly limited, an inverter circuit and a DC-DC converter circuit, which will be described later, of the inverter 20 are disposed on the lower surface 42b of the cover plate 42, and a control board 44 connected to the inverter circuit and DC-DC converter circuit of the inverter 20 is disposed on the upper surface 42a of the cover plate 42. The control board 44 includes components such as CPUs and a processor incorporating memories, and controls the operation of the inverter circuit and DC-DC converter circuit of the inverter 20. A protective cover 46 is provided on the cover plate 42. The protective cover 46 is a plate-shaped member, and is made of a conductive material such as iron, for example. The protective cover 46 covers the control board 44 located on the upper surface 42a of the cover plate 42. The terminal unit 30 is fixed to the housing body 41. Although not particularly limited, DC-DC converters 24 are located below the inverters 20 and are fixed at portions (not shown) of the housing body 41.

The inverter 20 is electrically connected to the plurality of motors 12 and 14, respectively. The inverter 20 includes inverter circuits and DC-DC converter circuits. DC-DC converter circuit boosts the DC power supplied from the battery 2 and supplies the boosted DC power to the inverter circuit. The inverter circuit is a three-phase AC inverter circuit. The DC power supplied from DC-DC converter is converted into AC power supplied to the plurality of motors 12 and 14, respectively. Here, the inverter 20 is an example of an “electrical circuit unit” in the technology disclosed in the present specification.

The inverter 20 is provided with a pair of first bus bars 22a and 22b. The supply power of the battery 2 is input to the inverter 20 via the pair of first bus bars 22a and 22b. Each of the pair of first bus bars 22a and 22b is generally a plate-shaped member. The pair of first bus bars 22a and 22b extends from the rear end face 20r of the inverter 20 to the terminal unit 30. The pair of first bus bars 22a and 22b includes a first positive electrode bus bar 22a and a first negative electrode bus bar 22b. The first positive electrode bus bar 22a is electrically connected to the positive electrode of the battery 2 of the vehicle, and the first negative electrode bus bar 22b is electrically connected to the negative electrode of the battery 2 of the vehicle.

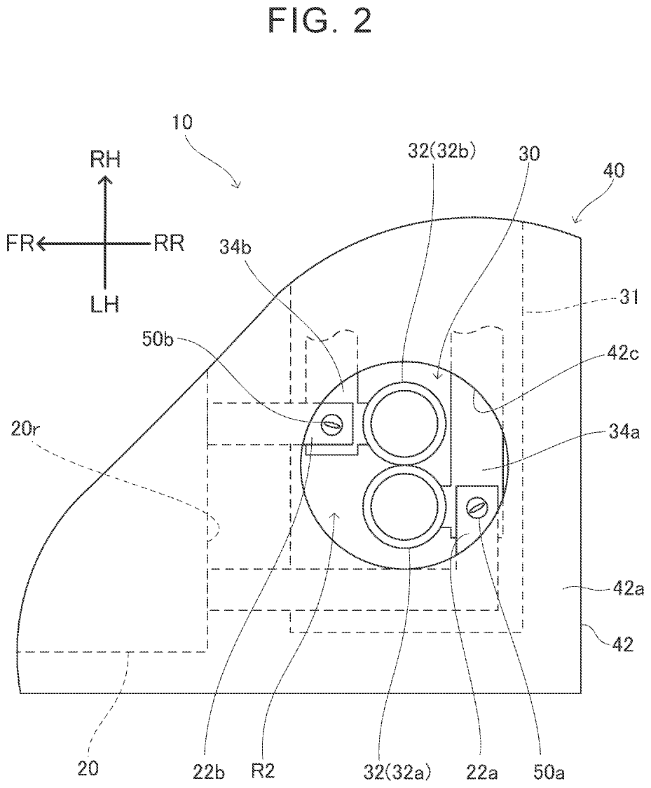

The terminal block 31 is generally formed using a plate-like member. The terminal block 31 has an upper portion 31a extending in the left-right direction, a lower portion 31b extending in the front-rear direction, and an intermediate portion 31c extending between the upper portion 31a and the lower portion 31b. An input socket 32 is provided in the upper portion 31a of the terminal block 31. As illustrated in FIG. 2, the input socket 32 includes a positive-electrode socket portion 32a and a negative-electrode socket portion 32b. Each of the positive electrode socket portion 32a and the negative electrode socket portion 32b is a cylindrical member, and is arranged side by side along the left-right direction. When the connector 4 is inserted into the input socket 32, the positive-electrode socket portion 32a is electrically connected to the positive electrode of the battery 2, and the negative-electrode socket portion 32b is electrically connected to the negative electrode of the battery 2.

A pair of first terminals 34a and 34b is provided on the upper surface of the upper portion 31a of the terminal block 31. The pair of first terminals 34a and 34b electrically connect between the terminal block 31 and the input socket 32. The pair of first terminals 34a and 34b includes a first positive electrode terminal 34a and a first negative electrode terminal 34b. The first positive electrode terminal 34a is located closer to the rear end side of the terminal block 31 than the input socket 32, and is electrically connected to the positive electrode socket portion 32a of the input socket 32 at the distal end portion of the first positive electrode terminal 34a. The first negative electrode terminal 34b is located closer to the front end side of the terminal block 31 than the input socket 32, and is electrically connected to the negative electrode socket portion 32b of the input socket 32 at the distal end portion of the first negative electrode terminal 34b.

In addition, a pair of first fastening portions 50a and 50b is provided in the electromechanical integration unit 10. The pair of first fastening portions 50a and 50b connect the terminal unit 30 and the inverter 20 to each other. The pair of first fastening portions 50a and 50b includes a first positive electrode fastening portion 50a located on the positive electrode side and a first negative electrode fastening portion 50b located on the negative electrode side in connection between the terminal unit 30 and the inverter 20. The first positive electrode terminal 34a of the terminal unit 30 is connected to the first positive electrode bus bar 22a of the inverter 20 at the first positive electrode fastening portion 50a, and the first negative electrode terminal 34b of the terminal unit 30 is connected to the first negative electrode bus bar 22b of the inverter 20 at the first negative electrode fastening portion 50b.

The lower portion 31b of the terminal block 31 protrudes forward from the intermediate portion 31c. The lower portion 31b of the terminal block 31 is fixed on the partition wall 41w of the housing body 41. The lower portion 31b of the terminal block 31, the front end portion, a pair of second terminals 36a, 36b is provided. The pair of second terminals 36a and 36b includes a second positive electrode terminal 36a and a second negative electrode terminal 36b. The second positive electrode terminal 36a is electrically connected to the first positive electrode terminal 34a, and the second negative electrode terminal 36b is electrically connected to the first negative electrode terminal 34b.

DC-DC converter 24 includes DC-DC converter circuit. DC-DC converter 24 converts the DC power supplied from the battery 2 into the charge power supplied to the auxiliary battery 6 of the vehicle. Specifically, DC-DC converters 24 step down the DC power supplied from the battery 2 and supply the DC power to the auxiliary battery 6. The rated voltage of the auxiliary battery 6 is 12 volts. The auxiliary battery 6 is connected to and supplies power to various control systems and other auxiliary equipment of the vehicle. Here, DC-DC converters 24 are exemplary “second electrical circuit units” in the techniques disclosed in this specification.

DC-DC converters 24 are provided with a pair of second bus bars 26a and 26b. The electric power supplied from the battery 2 is inputted to DC-DC converters 24 via the pair of second bus bars 26a and 26b. Each of the pair of second bus bars 26a and 26b is generally a plate-shaped member. The pair of second bus bars 26a and 26b extends from the rear end face 24r of DC-DC converter 24 to the terminal unit 30. The pair of second bus bars 26a and 26b includes a second positive bus bar 26a and a second negative bus bar 26b. The second positive electrode bus bar 26a is electrically connected to the positive electrode of the battery 2 of the vehicle, and the second negative electrode bus bar 26b is electrically connected to the negative electrode of the battery 2 of the vehicle.

The electromechanical integration unit 10 is provided with a pair of second fastening portions 52a and 52b. The pair of second fastening portions 52a and 52b connects the terminal unit 30 and DC-DC converters 24 to each other. The pair of second fastening portions 52a and 52b includes a second positive electrode fastening portion 52a located on the positive electrode side and a second negative electrode fastening portion 52b located on the negative electrode side in connection between the terminal unit 30 and DC-DC converters 24. The second positive electrode terminal 36a of the terminal unit 30 is connected to the second positive electrode bus bar 26a of DC-DC converter 24 at the second positive electrode fastening portion 52a, and the second negative electrode terminal 36b of the terminal unit 30 is connected to the second negative electrode bus bar 26b of DC-DC converter 24 at the second negative electrode fastening portion 52b.

The output socket 38 of the terminal unit 30 is detachably connected to the connector 7 of the cable 8 connected to the air-conditioning compressor 9 of the vehicle. Thus, the air-conditioning compressor 9 is electrically connected to the battery 2 via the terminal unit 30. However, the present disclosure is not limited to the air-conditioning compressor 9, and the output socket 38 may be connectable to other internal devices of the vehicle.

Here, with reference to FIG. 2, a detailed configuration of the electromechanical integration unit 10 in the vicinity of the first connector insertion port 42c will be described. As shown in FIG. 2, the first connector insertion port 42c is provided in the second chamber R2 of the housing 40. When the electromechanical integration unit 10 is viewed from above, the input socket 32 is located inside the inner peripheral edge of the first connector insertion port 42c. That is, the input socket 32 is exposed to the outside through the first connector insertion port 42c. In addition, the first connector insertion port 42c is provided so that the connector 4 of the power cable 3 of the battery 2 can be inserted. Here, the first connector insertion port 42c is an example of a “connector insertion port” in the technology disclosed in the present specification. The cover plate 42 is not limited, and the first connector insertion port 42c may be provided in the housing body 41.

Further, the electromechanical integration unit 10 is provided with a pair of first fastening portions 50a and 50b in a range exposed to the outside through the first connector insertion port 42c. The pair of first fastening portions 50a and 50b connect the terminal unit 30 and the inverter 20 to each other.

In the present embodiment, the first positive electrode fastening portions 50a of the pair of first fastening portions 50a and 50b are located on the rear side of the input socket 32. On the other hand, the first negative electrode fastening portions 50b of the pair of first fastening portions 50a and 50b are located on the front side of the input socket 32. According to such a configuration, the opening area of the first connector insertion port 42c can be reduced as compared with the case where both of the pair of first fastening portions 50a and 50b are located on the same side of the input socket 32. This makes it possible to reduce the size and improve the rigidity of the housing 40.

A second connector insertion port 41d is provided in the second chamber R2 of the housing 40. The second connector insertion port 41d is provided in the side wall 41b of the housing body 41 and opens to the rear portion of the housing body 41. The second connector insertion port 41d exposes the output socket 38 to the outside. The second connector insertion port 41d is provided so that the connector 7 to the cable 8 connected to the air-conditioning compressor 9 can be inserted.

In the above-described electromechanical integration unit, one or a plurality of service holes are usually formed in the housing in order to fasten components disposed in the housing. However, forming a service hole in the housing may lead to an increase in the size of the housing and a decrease in rigidity.

In order to solve the above problem, in the electromechanical integration unit 10 according to the present embodiment, the connector 4 of the power cable 3 extending from the battery 2 is attached to and detached from the first connector insertion port 42c provided in the housing 40. When the connector 4 is removed from the first connector insertion port 42c, a pair of first fastening portions 50a and 50b for connecting the terminal unit 30 and the electrical circuit unit 18 to each other is provided in a range exposed to the outside through the first connector insertion port 42c. Accordingly, the first connector insertion port 42c can also function as a service hole for the pair of first fastening portions 50a and 50b, and the number of service holes can be reduced by that amount. Further, the first connector insertion port 42c which is closed by the connector 4 of the power cable 3, by functioning also as a service hole, since, in some embodiments, the service hole cover to the service hole is also unnecessary, it is also possible to reduce the number of parts required.

The housing 40 in the present embodiment includes a housing body 41 having an opening 41c in the second chamber R2, and a cover plate 42 detachably attached to the opening 41c of the housing body 41. In addition, the terminal unit 30 is fixed to the housing body 41, and the inverter 20 is fixed to the cover plate 42. According to such a configuration, after the cover plate 42 is attached to the housing body 41, the terminal unit 30 and the inverter 20 can be fastened to each other through the first connector insertion port 42c.

Here, with reference to FIG. 1, the assembling method in the second chamber R2 of the electromechanical integration unit 10 will be described in detail. First, the lower portion 31b of the terminal block 31 of the terminal unit 30 is mounted on the partition wall 41w of the housing body 41. DC-DC converters 24 are then attached to the housing body 41. At this time, DC-DC converters 24 are arranged such that the pair of second bus bars 26a and 26b are in contact with the pair of second terminals 36a and 36b of the terminal unit 30. Next, the pair of second bus bars 26a and 26b of DC-DC converters 24 and the pair of second terminals 36a and 36b of the terminal unit 30 are fastened to each other. The inverter 20 is then attached to the cover plate 42. At this time, the inverter circuit and the converter circuit of the inverter 20 are disposed on the lower surface 42b of the cover plate 42, and the control board 44 is disposed on the upper surface 42a of the cover plate 42. A protective cover 46 is then mounted on the control board 44 disposed on the cover plate 42. Then, the cover plate 42 to which the inverter 20 is attached is attached to the opening 41c of the housing body 41. At this time, in the cover plate 42, the first connector insertion port 42c is positioned directly above the input socket 32 of the terminal unit 30, and the pair of first bus bars 22a and 22b of the inverter 20 are arranged so as to be in contact with the first terminals 34a and 34b of the terminal unit 30. Finally, the first terminals 34a and 34b of the terminal unit 30 and the pair of first bus bars 22a and 22b of the inverter 20 are fastened to each other through the first connector insertion port 42c. As a result, the assembly of the electromechanical integration unit 10 is completed. When the electromechanical integration unit 10 is mounted on a vehicle, the connector 4 of the power cable 3 is inserted into the input socket 32 through the first connector insertion port 42c.

Although the specific examples disclosed by the present disclosure have been described in detail above, these are merely examples and do not limit the scope of claims. The techniques described in the claims include various modifications and alternations of the specific examples illustrated above. The technical elements described in this specification or in the drawings may be used alone or in various combinations, and are not limited to the combinations described in the claims at the time of filing. The technology illustrated in the present specification or the drawings can achieve a plurality of objects at the same time, and has technical usefulness in achieving one of the objects.

What is claimed is:

1. An electromechanical integration unit mounted in a vehicle, the electromechanical integration unit comprising:
a housing configured to include a first chamber and a second chamber;
a motor and a gear mechanism housed in the first chamber of the housing and configured to be connected to a wheel of the vehicle;
an electrical circuit unit housed in the second chamber of the housing and configured to be electrically connected to the motor; and
a terminal unit housed in the second chamber of the housing and electrically connected to the electrical circuit unit, and configured to include a socket to which a connector of a power cable connected to a battery of the vehicle is detachably connected, wherein:
in the second chamber of the housing, a connector insertion port is provided so as to externally expose the socket and allow the connector to be inserted; and
a pair of fastening portions for connecting the terminal unit and the electrical circuit unit to each other is provided in a range externally exposed through the connector insertion port.

2. The electromechanical integration unit according to claim 1, wherein:
the housing is configured to include a housing body provided with an opening in the second chamber and a cover plate detachably attached to the opening of the housing body;
the terminal unit is fixed to the housing body; and
the electrical circuit unit is fixed to the cover plate.

3. The electromechanical integration unit according to claim 2, wherein the connector insertion port is configured to be provided in the cover plate.

4. The electromechanical integration unit according to claim 1, wherein:
one of the fastening portions is configured to be located on one side of the socket; and
the other of the fastening portions is configured to be located on the other side of the socket.

5. The electromechanical integration unit according to claim 1, wherein the electrical circuit unit is configured to convert a direct-current power supplied from the battery into an alternating-current power supplied to the motor.

6. The electromechanical integration unit according to claim 1, further comprising a second electrical circuit unit housed in the second chamber of the housing and configured to be electrically connected to the terminal unit, wherein the second electrical circuit unit is configured to convert a direct-current power supplied from the battery to a charge power supplied to an auxiliary battery of the vehicle.
